(19) United States
(12) Patent Application Publication
(10) Pub. No.: US 2014/0157128 A1
(43) Pub. Date: Jun. 5, 2014

(54) SYSTEMS AND METHODS FOR PROCESSING SIMULTANEOUSLY RECEIVED USER INPUTS

(71) Applicant: EMO2 INC., Palo Alto, CA (US)

(72) Inventor: Mir Abid HUSSAIN, Kerala (IN)

(73) Assignee: EMO2 INC., Palo Alto, CA (US)

(21) Appl. No.: 13/691,162

(22) Filed: Nov. 30, 2012

(51) Int. Cl. G06F 3/0481; G06F 3/16

(52) U.S. Cl. CPC G06F 3/0481; G06F 3/167
USPC 715/727

(57) ABSTRACT

In a multiuser touch sensitive display device including a touch sensitive display screen capable of displaying a plurality of windows for interacting with a plurality of users simultaneously, each window providing a user interface for a running instance of an application program run by one of the plurality of users for receiving touch sensitive inputs and displaying content output of the application program instance, and a plurality of output ports that can be coupled to a plurality of peripheral devices including audio output devices for generating audio outputs, wherein the multiuser touch sensitive display device runs an operating system module that can simultaneously interact with a plurality of instances of one or more application programs, a method is provided for processing simultaneously received user inputs through the plurality of windows displayed on the touch sensitive display screen.

### CROSS REFERENCE TO RELATED APPLICATIONS

This application is related to the following applications filed concurrently herewith on Nov. 30, 2012:

U.S. patent application Ser. No. ______, entitled “Systems and Methods for Changing Orientation of Display Windows and Contents;”

U.S. patent application Ser. No. ______, entitled “Systems and Methods for Controlling a User's Ability to Browse the Internet;”

U.S. patent application Ser. No. ______, entitled “Systems and Methods for Authenticating a User Based on Multiple Inputs Received from Multiple Devices;”

U.S. patent application Ser. No. ______, entitled “Systems and Methods for Selectively Delivering Messages to Multiuser Touch Sensitive Display Devices;” and

U.S. patent application Ser. No. ______, entitled “Apparatus and Methods for Mounting a Multiuser Touch Sensitive Display Device.”

### FIELD OF THE INVENTION

The disclosed subject matter relates to the field of data processing devices, and more particularly but not exclusively to receiving and processing inputs provided to data processing devices.

### DISCUSSION OF THE RELATED FIELDS

Data processing devices (DPS), such as, computers, laptops, touch sensitive devices and communication devices are configured to execute multiple applications simultaneously. For example, a laptop can be used to execute multiple applications, such as a video player, an internet browser and a spread sheet processor, among other applications. Even though multiple applications are executed simultaneously, at any given point in time, a user can provide input to only one application window, using an input device. When one or more users are sharing a device having a touch sensitive display screen, multiple users are seated around the screen interacting with the touch screen device, users would wish to provide inputs to multiple application windows simultaneously. One user in this case may wish to read the news while the other plays a game. However, conventional technologies do not seem to support such a requirement on touch screens such as capacitive touch screens or in-cell technology based touch-screens where multiple users may engage with a display device simultaneously. Further conventional technologies are limited because they were never built to serve such a purpose. Further, in scenarios wherein multiple users are simultaneously using a DPS, conventional technologies do not seem to enable users to readily identify which of the users have initiated the application for execution.

Further, in scenarios wherein multiple users are simultaneously using a DPS, conventional technologies do not seems to enable the users to adjust the orientation and size of the applications to fit the space available.

### SUMMARY

In light of the foregoing discussion, there is a need for a technique to more effectively receive and process inputs provided to data processing devices and manage a multi-user environment where multiple users interact with a display device simultaneously or a single user interacts with multiple applications.

Accordingly the invention provides a system for processing inputs and managing a multi-user environment. A new system is invented that is created for allowing and managing multiple touch inputs sent to multiple application windows in a multi-user environment across all application windows. This new system will seamlessly pass and manage multi-touch inputs in every window across the system. As well as manage multiple input, output and size constraints presented by the touch screen environment.

The system includes a processing module. The processing module is configured to receive inputs simultaneously, identify applications to which each of the inputs correspond to, processes each of the inputs with respect to the identified applications and perform one or more actions based on processing of the inputs.

There is also provided a method for processing inputs provided simultaneously to a data processing system. The method includes the steps of receiving inputs simultaneously, identifying applications to which each of the inputs correspond to, processing each of the inputs with respect to the identified applications and performing one or more actions based on processing of the inputs.

There is further provided a method for managing a multi-user environment by accepting multiple users using the device simultaneously and multiple users may also choose to login into the device. A method by which users can identify the applications opened by them easily is presented and also methods are provided by which users may easily scale and rotate applications to fit and orient them in a multi-user, multi-application environment. Some of the methods and systems address the various challenges that are faced when multiple users interact with the multiple applications on the same display device simultaneously.

In a multiuser touch sensitive display device including a touch sensitive display screen capable of displaying a plurality of windows for interacting with a plurality of users simultaneously, each window providing a user interface for a running instance of an application program run by one of the plurality of users for receiving touch sensitive inputs and displaying content output of the application program instance, and a plurality of output ports that can be coupled to a plurality of peripheral devices including audio output devices for generating audio outputs, wherein the multiuser touch sensitive display device runs an operating system module that can simultaneously interact with a plurality of instances of one or more application programs, a method for processing simultaneously received user inputs through the plurality of windows displayed on the touch sensitive display screen, the method comprising: simultaneously receiving at the operating system module user inputs generated by a plurality of users from a plurality of windows displayed on the touch sensitive display screen, wherein the multiuser touch sensitive display device runs a plurality of application program instances, each application program instance having at least one of the plurality of windows for interacting with one of the plurality of users, and wherein each of the plurality of users owns at least one of the plurality of application program instances; identifying at the operating system module for each of the user inputs a corresponding application program instance of the plurality of application program instances that is intended for the each user input to send the each user input to the corresponding application program instance; and receiving at the operating system module outputs that are generated based on the user inputs from the corresponding application program instances, wherein the outputs include a plurality of audio outputs and a plurality of visual outputs; identifying at the operating system module for each of the plurality of visual outputs a corresponding window to display the each visual output on the corresponding window on the touch sensitive display screen; and identifying at the operating system module for each of the plurality of outputs a corresponding output port of the plurality of output ports that is associated with the corresponding application program instance to cause an audio device connected to the corresponding output port to generate the each audio output.

### BRIEF DESCRIPTION OF DRAWINGS

Embodiments are illustrated by way of example and not limitation in the Figures of the accompanying drawings, in which like references indicate similar elements and in which:

FIG. 1 illustrates a Data Processing Device (DPS) 100 executing two applications 102a and 102b simultaneously, in accordance with an embodiment;

FIG. 2 illustrates DPS 100 receiving inputs, simultaneously, corresponding to two applications 102, which are being executed simultaneously, in accordance with an embodiment;

FIG. 3 illustrates DPS 100 receiving inputs, simultaneously, corresponding to applications 102a and 102b through mouse and finger, respectively, in accordance with an embodiment;

FIG. 4 illustrates DPS 100 receiving inputs, simultaneously, corresponding to applications 102a and 102b through mouse and stylus, respectively, in accordance with an embodiment;

FIG. 5 is a block diagram illustrating a system for receiving and processing inputs provided to DPS 100, in accordance with an embodiment;

FIG. 6 is a flow chart illustrating a method of processing simultaneously received inputs, in accordance with an embodiment;

FIG. 7 illustrates DPS 100, wherein a virtual keypad 702 is assigned as an input means to means to 102a to one application while another application 102b simultaneously takes inputs from another user, in accordance with an embodiment;

FIG. 8 illustrates DPS 100 displaying ribbon 800 depicting input means, which users can select from, in accordance with an embodiment;

FIG. 9 illustrates DPS 100 executing two applications 102, in accordance with an embodiment;

FIG. 10 illustrates differentiation between applications, in accordance with an embodiment; and

FIG. 11 illustrates DPS 100, wherein application 102a has been moved to a second section of DPS 100, in accordance with an embodiment.

FIG. 12 illustrates DPS 100, wherein application 102b is being resized/scaled using a two finger pinch/zoom gesture to ensure 102a is visible on DPS 100 to the user, in accordance with an embodiment. Users may also then lock or hide content in the application window by a performing a gesture on the window.

### DETAILED DESCRIPTION

The following detailed description includes references to the accompanying drawings, which form a part of the detailed description. The drawings show illustrations in accordance with example embodiments. These example embodiments, which are also referred to herein as “examples,” are described in enough detail to enable those skilled in the art to practice the present subject matter. The embodiments can be combined, other embodiments can be utilized, or structural, logical, and electrical changes can be made without departing from the scope of what is claimed. The following detailed description is, therefore, not to be taken in a limiting sense, and the scope is defined by the appended claims and their equivalents.

In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

Reference will now be made in detail to embodiments, examples of which are illustrated in the accompanying drawings. In the following description, numerous specific details are set forth in order to provide a thorough understanding of the present invention. However, it will be apparent to a person with ordinary skill in the art that the present invention may be practiced without these specific details. In other instances, well-known methods, procedures, components, circuits, and networks have not been described in detail so as not to unnecessarily obscure aspects of the embodiments.

Embodiments disclose technique to more effectively receive and process inputs provided to data processing devices as well as manage a multi-user multi-application environment that is created as a result of enabling simultaneous data processing in applications. In-order to enable users to use the display device in a multi-user multi-application environment, we need to provide solutions for simultaneous input handling, output handling, user management, application identification, application scaling and application rotation. Such a scenario is envisioned in a café table which has a large touch screen attached to it towards the middle of the table and two users are seated opposite to each other on the coffee table.

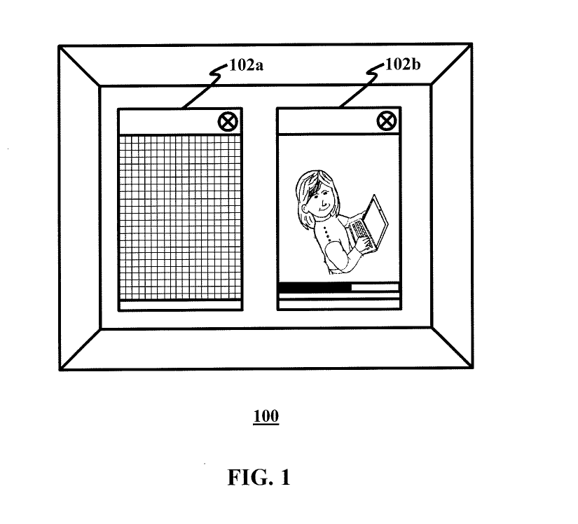

These two users start multiple applications on the display device and wish to interact with them smoothly, wherein FIG. 1 illustrates a Data Processing Device (DPS) 100 executing two applications 102a and 102b simultaneously, in accordance with an embodiment. DPS 100, can be, for example, a personal computer, laptop, tablet, a communication device and a touch sensitive device, among other data processing devices. DPS 100, in this example, is executing a spreadsheet application 102a and a video playing application 102b. Applications 102a and 102b can be collectively referred to as applications 102. Alternatively, when referring to a single application, the same may be referred to as application 102. It shall be noted that, DPS 100 can execute one or more applications simultaneously. When more than one application is being executed by DPS 100 simultaneously, one or more users may wish to provide inputs simultaneously to two or more applications 102, which are being executed simultaneously.

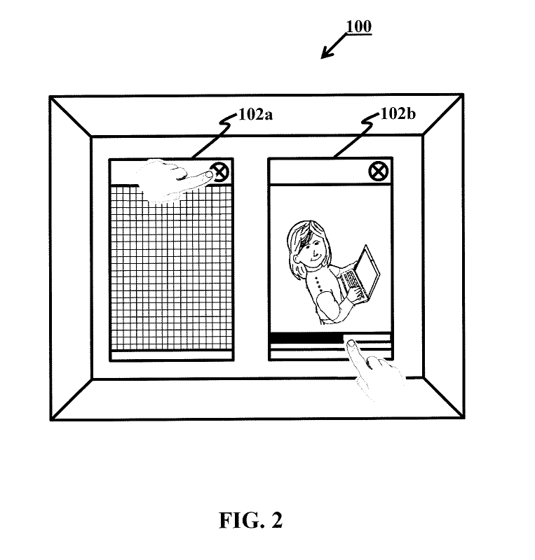

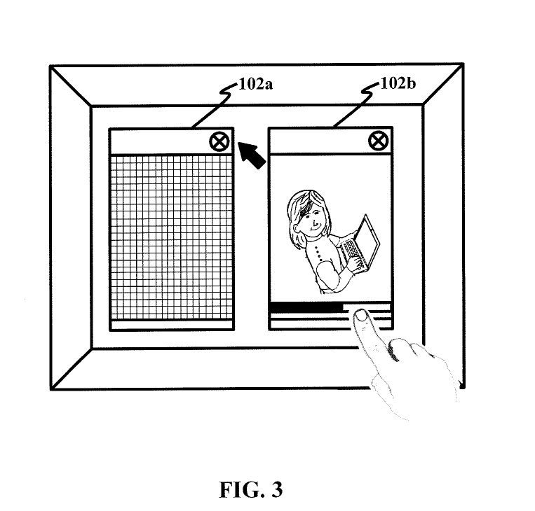

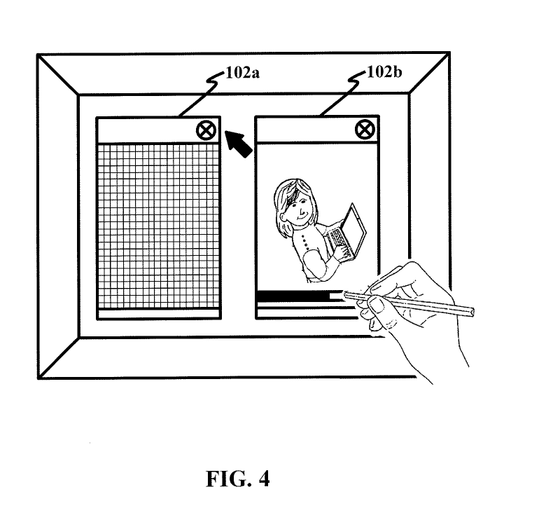

FIG. 2 illustrates DPS 100 receiving inputs, simultaneously, corresponding to two applications 102, which are being executed simultaneously, in accordance with an embodiment. In this example, a user is providing input to applications 102a and 102b using his fingers. The input means used by one or more users to provide inputs to DPS 102 can be, for example, keyboard, mouse, gestures, body part and stylus, among others. FIG. 3 illustrates DPS 100 receiving inputs, simultaneously, corresponding to applications 102a and 102b through mouse and finger, respectively, in accordance with an embodiment. Likewise, FIG. 4 illustrates DPS 100 receiving inputs, simultaneously, corresponding to applications 102a and 102b through mouse and stylus, respectively, in accordance with an embodiment.

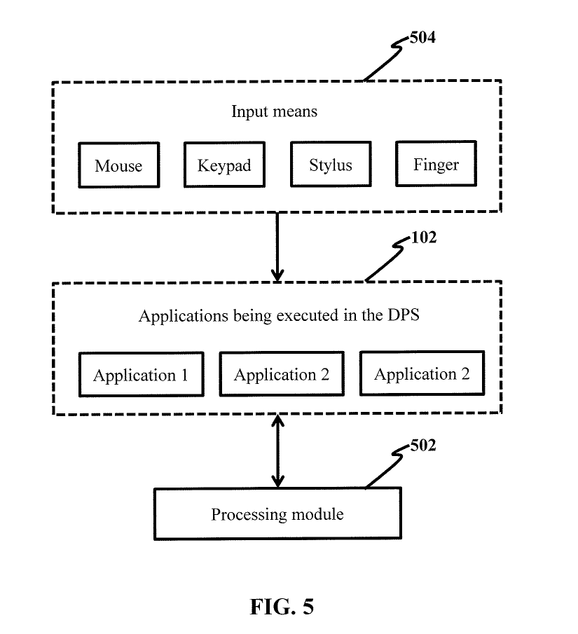

The multiple inputs received by DPS 100 are processed by processing module. FIG. 5 is a block diagram illustrating a system for receiving and processing inputs provided to DPS 100, in accordance with an embodiment. In the instant example, various types of input means 502, such as, mouse, keyboard, stylus and finger, are illustrated. However, a person with ordinary skill in the art will appreciate the fact that, DPS 100, based on its configuration, may be capable of receiving inputs from one or more of the aforementioned input means 504, or any other input means. The inputs can correspond to the applications 102 being executed by DPS 100. The inputs are processed by processing module 502.

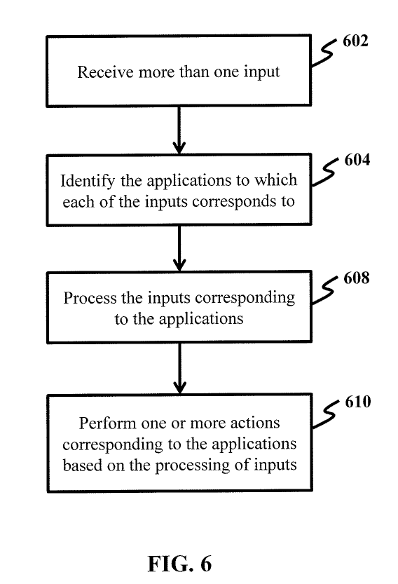

FIG. 6 is a flow chart illustrating a method of processing simultaneously received inputs, in accordance with an embodiment. At step 602, inputs are received. The inputs can be received by the processing module 502. At step 604, the processing module 502 identifies the applications 102 to which each of the inputs correspond to. Once the applications 102 are identified, at step 608, processing module 502 processes each of the inputs with respect to the applications 102 for which they were provided. Subsequently, at step 610, one or more actions are performed corresponding to each of the applications 102 for which inputs were provided.

In an embodiment, processing module 502 identifies an application 102 to which an input relates to, by recognizing a gesture made on the application. The gesture, for example, can be made using a mouse pointer, finger or stylus.

In an embodiment, processing module 502 identifies an application 102 to which an input relates to, by identifying the input means from which the input has been received, wherein the input means is assigned to an application 102. For example, one or more input means, such as, mouse, virtual keypad, keypad and stylus, may be assigned to an application. 102.

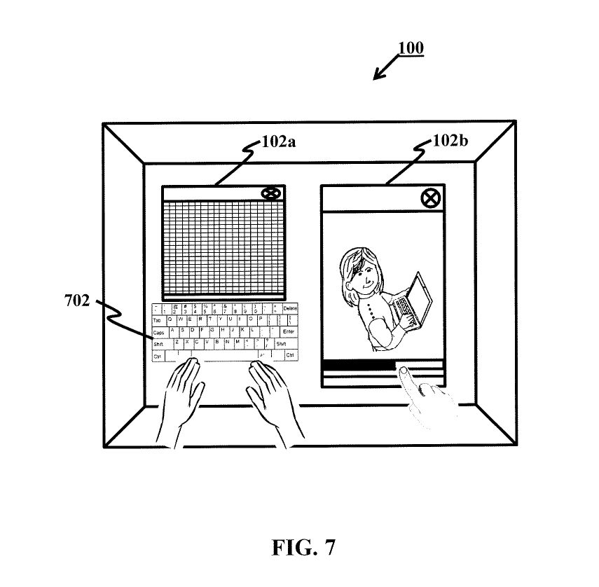

FIG. 7 illustrates DPS 100, wherein a virtual keypad 702 is assigned as an input means to an application 102a for one user, while another application 102b simultaneously takes inputs from another user, in accordance with an embodiment.

Processing module 502, after identifying the application 102 to which each of the inputs relate to, processes each of the inputs. The inputs, for example, may relate to saving a file, editing a file and changing the resolution of the file, among other inputs. Further, based on the processing, one or more actions are performed by the processing module 502. It may be noted that, based on the input, one or more actions taken by the processing module 502 may be reflected on the application 102, which may also indicate to the one or more users that an action desired by the user has been performed. Alternatively, if an action, desired by one or more users, to be performed, cannot be performed, then the same is notified to the users.

In an embodiment, the processing module 502 enables assigning of input means to applications 102 that are being or going to be executed by DPS 100.

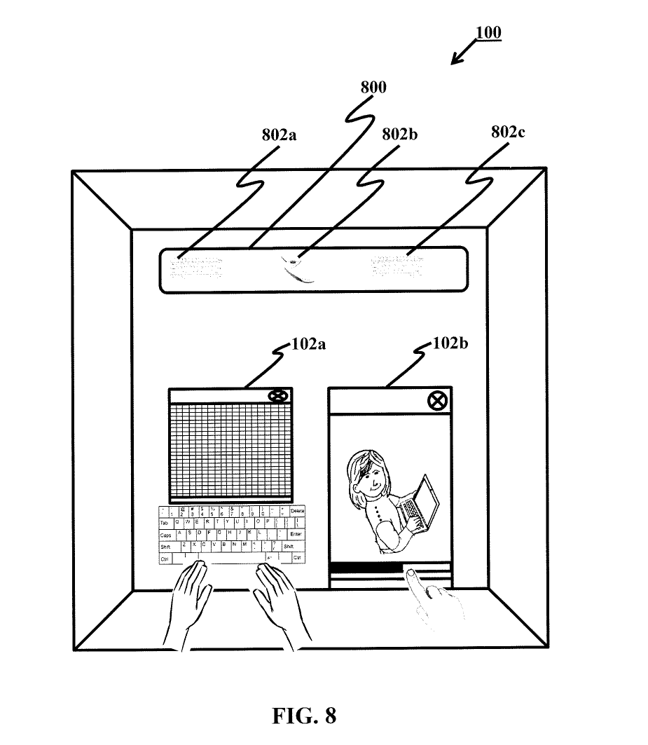

In an embodiment, DPS 100 displays a ribbon, illustrating input means, which users can select from. FIG. 8 illustrates DPS 100 displaying ribbon 800 depicting input means, which users can select from, in accordance with an embodiment. In this example, ribbon 800 depicts input means, such as, a virtual keypad 802a, a mouse 802b and physical keypad 802c. A user can drag and drop a depiction of input means 802 onto an application to assign the input means 802 to the respective application 102. When such an assignment of input means 802 is made to an application 102, the same is recorded by the processing means 502, which will be subsequently used to identify the applications 102 for which inputs are being provided.

In an embodiment, a user can drag and drop depiction of virtual keypad 802a and mouse 802b onto application 102a to assign the two input means to the application 102a.

In an embodiment, input means, such as a virtual keypad, may be opened when an application, such as a spreadsheet application, is opened.

In an embodiment, when a physical keypad 802c is assigned to an application 102, the same may be indicated to the user(s). The indication may be provided in the depiction of the physical keypad 802c. Alternatively, when such an assignment is made, the depiction of physical keypad 802c may not be shown in the ribbon 800.

In an embodiment, each application 102 may be provided with an option enabling a user to select an input means suitable to the application 102.

In an embodiment, each application 102 may be provided with an option enabling a user to select an output means suitable to the application 102. For example users could connect their Bluetooth headphones and pair them. The processing unit then will route audio from the applications to the correct headphones. So, if user 1 opened a music player and user 2 opened a video player and both users have paired their Bluetooth headsets then the audio from audio player application is made audible in user 1's headset and the audio from the video player is made audible in user 2's headset.

In an embodiment, processing module 502 is configured to receive multiple inputs simultaneously for an application 102 and process such inputs.

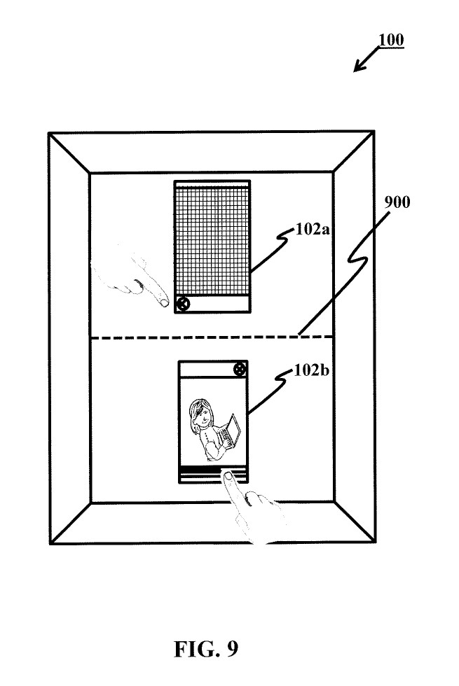

In an embodiment, processing module 502 is configured to depict differentiation between the applications 102 based on the users to whom the applications 102 relates to. FIG. 9 illustrates DPS 100 executing two applications 102, in accordance with an embodiment. In this example, DPS 100 display is virtually divided 900 into two sections. In the first section, a first user has initiated an application 102a and in the second section, a second user has initiated an application 102b.

In an embodiment, first user logs into DPS 100 through an interface provided in the first section. Users may log-in after they are authenticated by DPS 100 or through a remote server. Likewise, second user logs into DPS 100 through an interface provided in the second section or any other area on the screen. After logging in, the first user initiates first application 102a. Likewise, after logging in, the second user initiates second application 102b as shown in FIG. 9.

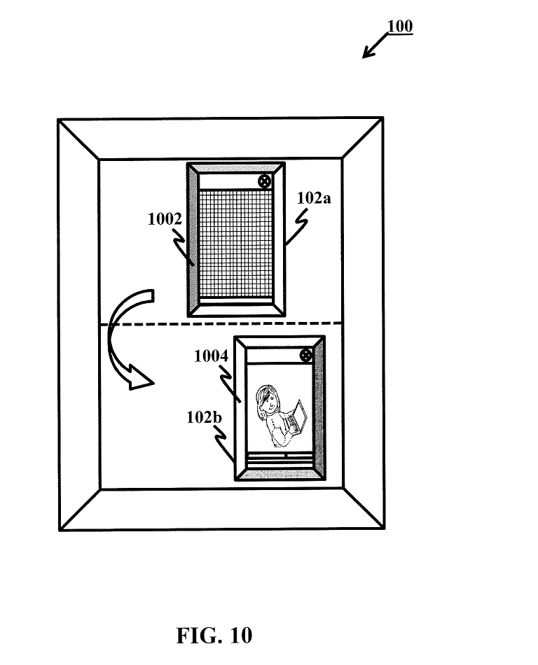

In an embodiment, processing module 502 differentiates between the applications initiated, by different users or in different sections. FIG. 10 illustrates differentiation between applications, in accordance with an embodiment. In an embodiment, when applications 102 initiated in each of the sections are within the respective sections, processing module may not indicate differentiation between the applications 102. Alternatively, in an embodiment, when applications 102 initiated in each of the sections are within the respective sections, processing module indicates differentiation between the applications 102.

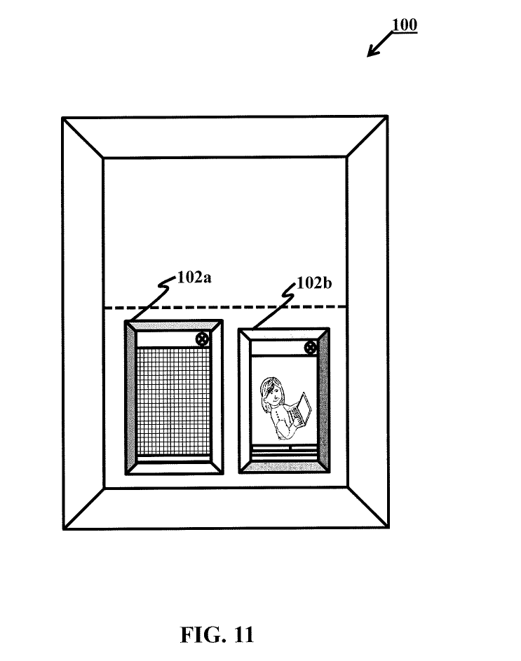

In an embodiment, only when an application 102 is moved from one section (where the application was initiated) of DPS 100 to another section of DPS 100, processing module 100 indicates differentiation between the applications 102. FIG. 11 illustrates DPS 100, wherein application 102a has been moved to a second section of DPS 100, in accordance with an embodiment.

In an embodiment, the differentiation between applications 102 is by way of visual representation (textures 1002 and 1004). The visual differentiation can be, for example, colour, texture and tag, among others.

In an embodiment, processing module 502 enables one or more users to differentiate between applications 102. For example, users are allowed to differentiate between applications by selecting, for example, colour, texture and tag, among others, for one or more of the applications 102.

In an embodiment, orientation of applications 102 can be changed. In an embodiment, the orientation is changed by using an orientation changing module, which allows orientation to be changed by a desired angle. Alternatively, orientation can be changed by providing two finger rotate gesture action over the application. To change the orientation, the two fingers are moved substantially parallel to the opposite direction over the application. The two finger rotate action applies to the application window and not to the document contained within the window. For example, user 1 is using a social media application 102a as shown in FIG. 9 while being seated on one side of a café table fitted which is fitted with a touch screen and while user 2 is seated on the other side of the table reading news on a news application 102b as shown in FIG. 9. User 1 finds an interesting comment on the social media application 102a that needs to be shown to user 2. Immediately, user 1 may use the two finger rotate gesture to turn and orient the entire 102a application in the direction of user 2 as shown in FIG. 10. During the action user 2 may not just rotate but also move the application 102a closer to user 2 and bring it to a position similar to what is shown in FIG. 11. User 2 may then read the comment on the social media application without any discomfort.

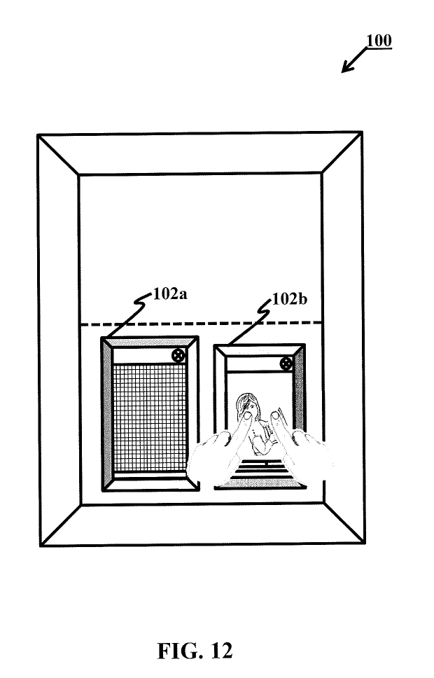

In an embodiment, applications 102 can be scaled up or scaled down as shown in FIG. 12. The scale of the applications 102 can be changed by providing two touch inputs using an object, such as user's fingers. To change the scale, the two fingers are moved substantially along a virtual straight line in opposite direction over the application. For example once the application 102a, the social media application from FIG. 11 is moved in position oriented towards user 2; user 2 may need to resize his news application 102b to accommodate application 102a. This can be done immediately using the 2 finger pinch and zoom action as shown in FIG. 12 which will resize/scale the entire application including the window itself and not just the content within the application to accommodate the social media application. Further a user can choose to lock his application window from any touch inputs being provided to the window in order to save his work from any accidental touches from another user. For example a parent can double tap an application to prevent a child from disturbing a drawing being drawn by the parent in a large table type display in the living room. Also a user can hide the content in the application to a smaller size icon by double tapping for example, in order to save space on the screen. Later when the user needs to application again, user may double tap again to show the content in the application.

The processes described above is described as sequence of steps, this was done solely for the sake of illustration. Accordingly, it is contemplated that some steps may be added, some steps may be omitted, the order of the steps may be re-arranged, or some steps may be performed simultaneously.

The example embodiments described herein may be implemented in an operating environment comprising software installed on a computer, in hardware, or in a combination of software and hardware.

Although embodiments have been described with reference to specific example embodiments, it will be evident that various modifications and changes may be made to these embodiments without departing from the broader spirit and scope of the system and method described herein. Accordingly, the specification and drawings are to be regarded in an illustrative rather than a restrictive sense.

Many alterations and modifications of the present invention will no doubt become apparent to a person of ordinary skill in the art after having read the foregoing description. It is to be understood that the phraseology or terminology employed herein is for the purpose of description and not of limitation. It is to be understood that the description above contains many specifications, these should not be construed as limiting the scope of the invention but as merely providing illustrations of some of the personally preferred embodiments of this invention. Thus the scope of the invention should be determined by the appended claims and their legal equivalents rather than by the examples given.

What is claimed is:

1. In a multiuser touch sensitive display device including a touch sensitive display screen capable of displaying a plurality of windows for interacting with a plurality of users simultaneously, each window providing a user interface for a running instance of an application program run by one of the plurality of users for receiving touch sensitive inputs and displaying content output of the application program instance, and a plurality of output ports that can be coupled to a plurality of peripheral devices including audio output devices for generating audio outputs, wherein the multiuser touch sensitive display device runs an operating system module that can simultaneously interact with a plurality of instances of one or more application programs, a method for processing simultaneously received user inputs through the plurality of windows displayed on the touch sensitive display screen, the method comprising:
simultaneously receiving at the operating system module user inputs generated by a plurality of users from a plurality of windows displayed on the touch sensitive display screen, wherein the multiuser touch sensitive display device runs a plurality of application program instances, each application program instance having at least one of the plurality of windows for interacting with one of the plurality of users, and wherein each of the plurality of users owns at least one of the plurality of application program instances;
identifying at the operating system module for each of the user inputs a corresponding application program instance of the plurality of application program instances that is intended for the each user input to send the each user input to the corresponding application program instance; and
receiving at the operating system module outputs that are generated based on the user inputs from the corresponding application program instances, wherein the outputs include a plurality of audio outputs and a plurality of visual outputs;
identifying at the operating system module for each of the plurality of visual outputs a corresponding window to display the each visual output on the corresponding window on the touch sensitive display screen; and
Identifying at the operating system module for each of the plurality of outputs a corresponding output port of the plurality of output ports that is associated with the corresponding application program instance to cause an audio device connected to the corresponding output port to generate the each audio output.

2. The method of claim 1, wherein the at least one window associated with the at least one of the plurality of application program instances that is owned by each of the plurality of users is differentiated using at least one of visual differentiation marks including colors, textures and visual tags.

3. The method of claim 1, wherein each of the windows associated with the plurality of application program instances is capable of being locked to prevent anyone other than an owner of the each window from entering touch sensitive inputs or accessing output content.

4. The method of claim 1, wherein a size of the windows associated with the plurality of application program instances can be adjusted in response to a touch sensitive user input.

5. The method of claim 1, wherein an orientation of the windows associated with the plurality of application program instances can be adjusted in response to a touch sensitive user input without changing an orientation of the multiuser touch sensitive display device.

6. The method of claim 1, wherein content displayed on the windows associated with the plurality of application program instances can be zoomed in or out in response to a touch sensitive user input.
